(19) United States
(12) Patent Application Publication
(10) Pub. No.: US 2012/0127385 A1
(43) Pub. Date: May 24, 2012

(54) LIQUID CRYSTAL DISPLAY DEVICE AND LIQUID CRYSTAL DISPLAY APPARATUS

(75) Inventor: Masaki NOSE, Kawasaki (JP)

(73) Assignee: FUJITSU LIMITED, Kawasaki-shi (JP)

(21) Appl. No.: 13/291,721

(22) Filed: Nov. 8, 2011

(30) Foreign Application Priority Data
Nov. 18, 2010 (JP) 2010-257648

(51) Int. Cl. G02F 1/133

(52) U.S. Cl. 349/33

(57) ABSTRACT

A liquid crystal display device includes a first liquid crystal layer where first liquid crystal regions and second liquid crystal regions are alternately arranged, and a second liquid crystal layer stacked on the first liquid crystal layer where third liquid crystal regions and fourth liquid crystal regions are alternately arranged. With respect to an area per pixel, the first liquid crystal region is larger than the second liquid crystal region, and the third liquid crystal region is larger than the fourth liquid crystal region. The first liquid crystal region overlaps part of the third liquid crystal region and the fourth liquid crystal region. The first, the second, the third and the fourth liquid crystal regions cause changes in reflectance of light at respective wavelength regions in response to applied voltage. The respective wavelength regions are different from one another.

### CROSS-REFERENCE TO RELATED APPLICATION

This application is based upon and claims the benefit of priority of the prior Japanese Patent Application No. 2010-257648 filed on Nov. 18, 2010, the entire contents of which are incorporated herein by reference.

### FIELD

Embodiments of the present invention relate to a liquid crystal display device and a liquid crystal display apparatus.

### BACKGROUND

In recent years, a technical field of electronic paper, which is able to retain display even without electric power source and being electrically rewritable, has been rapidly developed. Electronic paper aims for realizing an indefatigable, flexible, easy-on-the-eyes thin display body with an extremely low power consumption while being capable of memory display even if electric power is turned off. Applications of electronic paper to electronic book, electronic newspaper, electronic poster, etc., have advanced. Examples of display systems, which have been developed, include an electrophoretic system that moves electrically charged particles in air or liquid; a twist-ball system that rotates electrically charged particles separated in two colors; organic EL system and a cholesteric liquid-crystal system, which is a bi-stable selective reflection type using an interference reflection of the liquid crystal layer.

Among these various systems, the cholesteric liquid crystal system is predominant in “memory function”, “low power consumption”, “colorization”, and the like. In particular, it is an advantageous system for color display. Any of the systems other than the cholesteric system should be provided with color filters which are colored with three different colors for every pixel. Thus, the brightness of such a system is one third in maximum, so that it may be practically insufficient. In contrast, the cholesteric liquid crystal system reflects a color by interference of liquid crystals. Thus, color display can be produced just by lamination, so that a brightness of nearly 50% or more may be obtained.

Cholesteric liquid crystals may be also referred to as chiral nematic liquid crystals. That is, when a chiral additive (also referred to as a chiral material) in comparatively large amount (several tens of %) is added to nematic liquid crystals, the nematic liquid crystal molecules form a spiral cholesteric phase. Cholesteric liquid crystals control a display by the oriented state of the liquid crystal molecules.

FIG. 1A and FIG. 1B are diagrams illustrating two different states of cholesteric liquid crystals, respectively. As illustrated in FIG. 1A and FIG. 1B, a display device 10 using cholesteric liquid crystals includes an upper substrate 11, a cholesteric liquid crystal layer 12, and a lower substrate 13. The cholesteric liquid crystals take two different states, a planar state where incident light is reflected as illustrated in FIG. 1A and a focal conic state where incident light is reflected as illustrated in FIG. 1B. These states are stable even under no electric field, and the states are maintained. There is another state, called a homeotropic state, where all liquid crystal molecules are aligned along the direction of an electric field when a strong electric field is applied. However, when the application of the electric field is stopped, the homeotropic state is changed to the planar state or the focal conic state.

In the planar state, the liquid crystals reflect light at a wavelength corresponding to a helical pitch of a liquid crystal molecule. Wavelength λ that gives the maximum reflection is represented by the following equation in terms of a mean refractive index n and a helical pitch p of the liquid crystal molecule.

λ=n·p

On the other hand, a reflection band Δλ increases with a refractive index anisotropy Δn of the liquid crystal molecule.

In a planar state, incident light is reflected. Thus, a “bright” state, or a “white” state may be displayed. On the other hand, a light absorption layer is placed under the lower substrate 13 in the focal conic state. Thus, light passed through the liquid crystal layer 12 is absorbed in the light absorption layer. Thus, a “dark” state, or a “black” state may be displayed. Furthermore, there is another state where planar-state liquid crystal molecules and focal-conic-state liquid crystal molecules are mixed. In this case, a mixture of “bright” and “dark” causes a halftone state. The halftone state level depends on a ratio of the planar-state liquid crystal molecules to focal-conic-state liquid crystal molecules in the mixture.

There are various kinds of methods for controlling the state of cholesteric liquid crystals. Among them, a conventional drive method applies a strong electric field to the liquid crystals to cause a homeotropic state, followed by suddenly dropping the application of electric field to cause a planar state. The planar state is a “bright” state. In order to change from the “bright” state to the “dark” state, a comparatively small electric field is applied in the planar state in a short period of time. A voltage or a pulse width under such conditions, e.g., the level of “dark” state, or the “halftone” level may be determined. Note that other methods, such as a dynamic driving scheme (DDS), are also known in the art.

FIG. 2 is a diagram schematically illustrating the configuration of a reflective type color liquid crystal display device where three cholesteric liquid crystal layers, a blue panel 10B, a green panel 10G, and a red panel 10R, are stacked in order viewed from the observer side. Furthermore, a light absorption layer 17 is placed under the led panel 10R. These panels 10B, 10G, and 10R have the substantially the same configuration, except that they have their own selected crystal liquid materials and chiral materials with the predetermined contents of the chiral materials. That is, these conditions may be determined so that the panel 10B may have a reflection center wavelength of about 480 nm (blue), the panel 10G may have a reflection center wavelength of about 550 nm (green), and the panel 10R may have a reflection center wavelength of about 630 nm (red). Scan electrodes and data electrodes of the respective panels 10B, 10G, and 10R are driven by a common driver and a segment driver. Thus, the panels 10B, 10G, and 10R may have the same configuration, except for their different reflection center wavelengths.

FIG. 3 is a diagram illustrating exemplary reflection properties of panels 10B, 10G, and 10R. In the figure, B illustrates the reflection property of panel 10B, G illustrates the reflection property of panel 10G, and R illustrates the reflection property of panel 10R.

Blue (B) is displayed when only the panel B is in the planar state and other panels 10G and 10R are in the focal conic state. Green (G) is displayed when only the panel G is in the planar state and other panels 10B and 10R are in the focal conic state. Red (R) is displayed when only the panel R is in the planar state and other panels 10B and 10G are in the focal conic state. White (W) is displayed when all the panels 10B, 10G, and 10R are in the planer state. Black is displayed when all the panels 10B, 10G, and 10R are in the focal conic state.

As described above, the panels 10B, 10G, and 10R have the same configuration, except for their different reflective center wavelengths. FIG. 4A and FIG. 4B are diagrams illustrating basic configurations of panels 10B, 10G, and 10R, where FIG. 4A is a top view and FIG. 4B is a cross-sectional view.

As illustrated in FIG. 4A, a display device 10A includes an upper substrate 11, a plurality of upper electrodes 14 arranged in parallel along the surface of the upper substrate 11, a plurality of lower electrode layers 15 arranged in parallel along the surface of a lower substrate 13, and a sealant 16. The electrodes are arranged on the upper substrate 11 and the lower substrate 13 so that the corresponding electrodes are opposite to each other. In addition, cholesteric liquid crystals are enclosed between the upper substrate 11 and lower substrate 13 to form a liquid crystal layer 12, followed by being sealed with a sealant 16. Here, a spacer is arranged in the liquid crystal layer 12 but not illustrated in the figure. The upper electrodes 14 and the lower electrodes 15 are arranged so that these electrodes intersect perpendicularly when viewed from the observer side and their crossing portion corresponds to one pixel. Voltage pulse signals are applied to both the upper electrodes 14 and the lower electrodes 15. As a result, a voltage is applied to the liquid crystal layer 12. Thus, the application of voltage to the liquid crystal layer 12 brings the liquid crystal molecules in the liquid crystal layer 12 into a planar state or a focal conic state, thereby providing a display. The upper substrate 11 and the lower substrate 13 have translucency. However, the lower substrate 13 of the panel 10R may be impenetrable to light.

The upper electrodes 14 and the lower electrodes 15 of the panels 10B, 10G, and 10R are arranged so as to be overlapped when viewed from the observer side. Thus, pixels on three layers are overlapped, so that color display with color RGB can be performed. A halftone display may be performed every pixel to provide a full-color RGB color display.

For convenience, further description about a cholesteric liquid crystal display device and a drive method thereof will be omitted.

As described above, and as illustrated in FIG. 2, the three-layer laminated structure has been used for the cholesteric liquid crystal display device in order to realize a color display. However, when a reduction in number of layers is desired for cost reduction, in order to perform a color display with two or more layers, a plurality of liquid crystal portions may be formed on one layer. A plurality of liquid crystal portions of each layer may be partitioned. Structurally, the minimum structure is one having one layer on which three liquid crystal portions for RGB are partitioned and formed. However, a two-layered structure has been proposed since a one-layer structure lacks sufficient brightness.

Compared with a three-layer structure, a reflective type color liquid crystal display device having a conventional two-layer structure has a smaller interface reflection of any of various members as much as a decrease in number of the layers. On the other hand, the brightness of the two-layer structure is lower than that of the three-layer structure.

Japanese Laid-Open Patent Publication Nos. 9-068702 and 2001-242315 are examples of related art.

### SUMMARY

According to an aspect of the embodiment, a liquid crystal display device includes: a first liquid crystal layer where first liquid crystal regions and second liquid crystal regions are alternately arranged; and a second liquid crystal layer stacked on the first liquid crystal layer, where third liquid crystal regions and fourth liquid crystal regions are alternately arranged. With respect to an area per pixel, the first liquid crystal region is larger than the second liquid crystal region, and the third liquid crystal region is larger than the fourth liquid crystal region. The first liquid crystal region overlaps part of the third liquid crystal region and the fourth liquid crystal region. The first liquid crystal region causes a change in reflectance of light at a first wavelength region in response to applied voltage. The second liquid crystal region causes a change in reflectance of light at a second wavelength region in response to applied voltage. The third liquid crystal region causes a change in reflectance of light at a third wavelength region in response to applied voltage, and the fourth liquid crystal region causes a change in reflectance of light at a fourth wavelength region in response to applied voltage. The first wavelength region, the second wavelength region, the third wavelength region, and the fourth wavelength region are different from one another.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A and FIG. 1B are diagrams each illustrating the state of cholesteric liquid crystals;

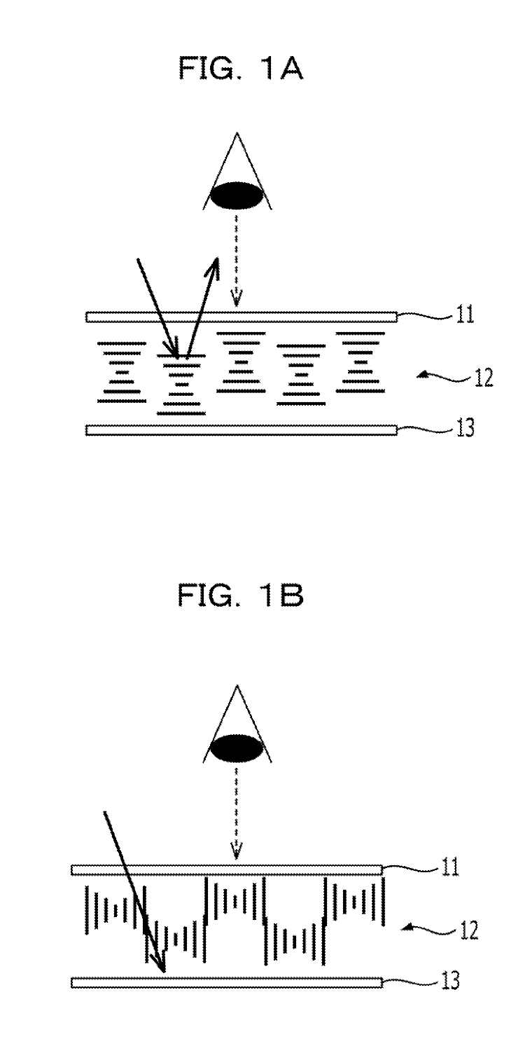

FIG. 2 is a diagram schematically illustrating the configuration of the reflective type color liquid crystal display device in which three cholesteric liquid crystal layers are stacked;

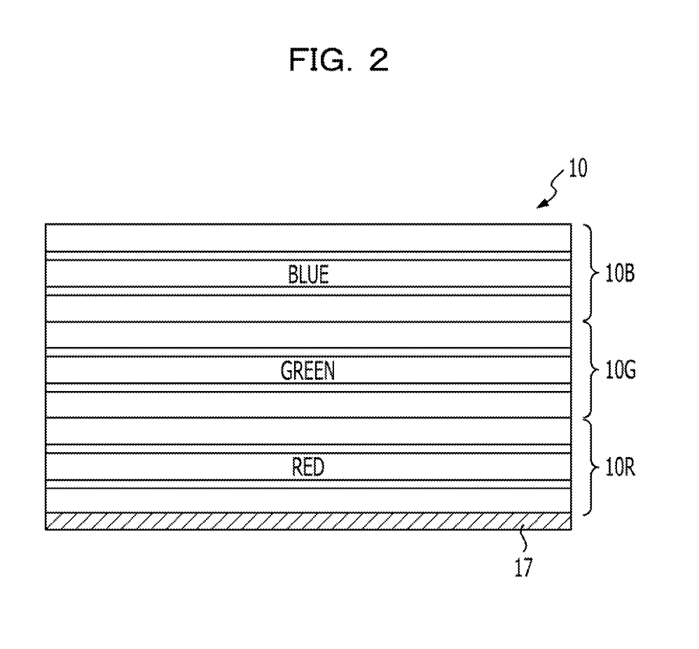

FIG. 3 is a diagram illustrating an exemplary reflection property of a RGB panel in a planar state;

FIG. 4A and FIG. 4B are diagrams illustrating a top view and a cross-sectional view of a RGB panel, respectively;

FIGS. 5A to 5C are diagrams each illustrating reflective type color liquid crystal display device according to a first embodiment;

FIGS. 6A to 6C are diagrams each illustrating a state where liquid crystal regions of two layers are overlapped;

FIG. 7 is a diagram illustrating a reflection spectrum when first to fourth liquid crystal regions are brought into a planar state according to a first embodiment;

FIG. 8A and FIG. 8B are cross-sectional diagrams of a reflective type color display device as a modified example of the first embodiment, where a cut filter is placed on the third liquid crystal region expressing red color.

FIG. 9A and FIG. 9B are diagrams illustrating color volumes of a comparative example and a modified example of the first embodiment, respectively;

FIG. 10A and FIG. 10B are cross-sectional diagrams of a reflective type color display device according to a second embodiment;

FIG. 11 is a diagram illustrating a transmission spectrum of a green-cut filter in the second embodiment;

FIGS. 12A to 12C are diagrams illustrating an enlarged view of a cross section of a reflective type color display device of a third embodiment and a view representing a pixel configuration and display colors, respectively; and

FIG. 13 is a block diagram illustrating the schematic configuration of the reflective color LCD panel which uses the reflective type color liquid crystal display apparatus using a reflective type color liquid crystal display devices of any of first to third modified embodiments.

### DESCRIPTION OF EMBODIMENTS

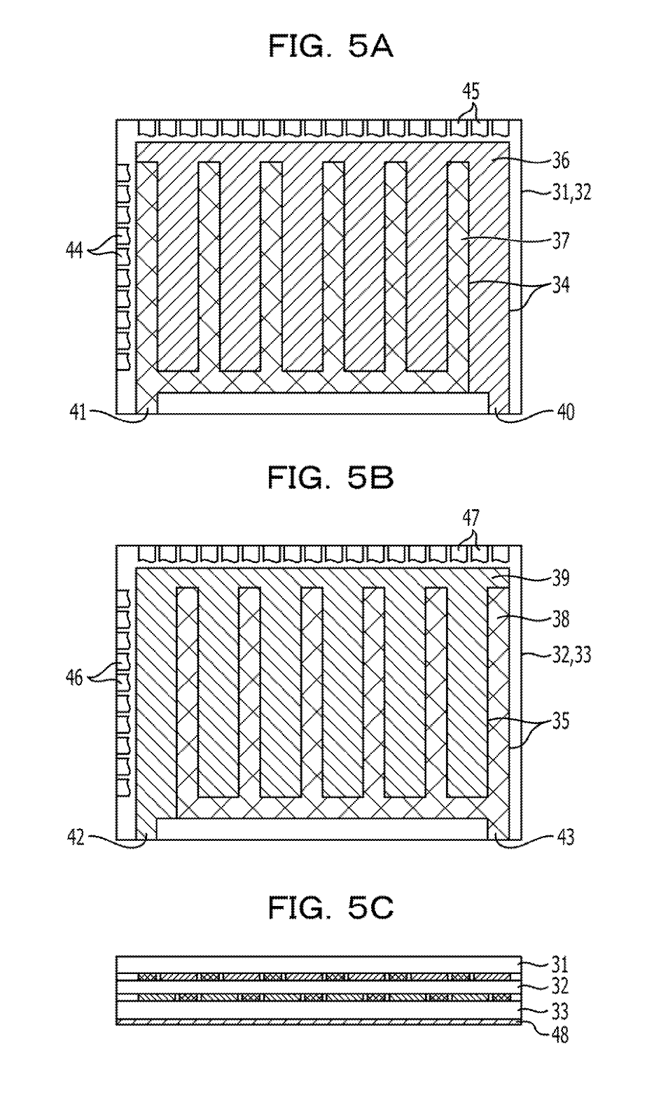

Realization of a reflective type color liquid crystal display device having two layer structures, which may obtain substantially the same image quality as that of the conventional three-layer structure while limiting or preventing the decrease in brightness, is desirable. FIGS. 5A to 5C are diagrams each illustrating a reflective type color liquid crystal display device of a first embodiment. FIG. 5A illustrates the configuration of a first liquid crystal layer as a first layer. FIG. 5B illustrates the configuration of a second liquid crystal layer as a second layer. FIG. 5C illustrates a cross-sectional diagram of a laminated structure. In FIGS. 5A to 5C, for simplifying the description, illustrated examples are those having a small number of band-shaped required crystal regions in the first to second liquid crystal layer. Typically, at least several hundred regions are preferable.

First, the configuration of a first liquid crystal layer will be described. As illustrated in FIG. 5A, a plurality of transparent electrodes 44 and a plurality of transparent electrodes 45, which extend in parallel with one another, are formed on the opposite surfaces of transparent substrates 31 and 32, respectively. The transparent electrodes 44 extend in a first direction and the transparent electrode 45 extend in a second direction. The transparent electrodes 44 and 45 are arranged perpendicular to each other when viewed from the observer side. Partitions 34 are formed between the transparent substrates 31 and 32 on which the transparent electrodes 44 and 45 are formed, so that a first liquid crystal region 36 and a second liquid crystal region 37, which are constructed of a plurality of alternately arranged bands extending in the second direction. Each band of the first liquid crystal region 36 has a width almost two times larger than that of each band of the second liquid crystal region. Each band of the first liquid crystal region 36 is arranged so as to be overlapped on two transparent electrodes 45. Each band of the second liquid crystal region 37 is arranged so as to be overlapped on a single transparent electrodes 45. All the bands of the first liquid crystal region 36 are connected to one another and liquid crystals may be poured into the inside through a liquid crystal supply inlet 40. In addition, all the bands of the second liquid crystal region 37 are connected to one another and liquid crystals may be poured into the inside through a liquid crystal supply inlet 41. A first liquid crystal layer 36 and a second liquid crystal layer 37, which is able to display two colors, may be obtained by injecting two different types of cholesteric liquid crystal layer with different reflexive light colors. In the first liquid crystal layer, the state of liquid crystals at a crossing portion between the transparent electrode 44 and the transparent electrode 45 may be controlled. As described later, this portion may correspond to one sub-pixel.

As illustrated in FIG. 5B, the second liquid crystal layer is also the same configuration as that of the first liquid crystal layer. To a plurality of third liquid crystal bands 38 and a plurality of fourth liquid crystal band 39, which are divided by partitions 35, two different cholesteric liquid crystals having different color reflection light are poured from inlets 42 and 43, respectively. Thus, a second liquid crystal layer capable of displaying two colors may be obtained. The width of the third liquid crystal band 38 is almost twice larger than that of the fourth liquid crystal band 39. In this second liquid crystal layer, the crossing portion between the transparent electrode 46 and the transparent electrode 47 corresponds to one sub-pixel.

As illustrated in FIG. 5C, the band of the first liquid crystal region 36 of the first liquid crystal layer overlaps half of the band of the third liquid crystal region 38 of the second liquid crystal layer and the band of the fourth liquid crystal region 39. The band of second liquid crystal region 37 of the first liquid crystal layer is arranged so that it may overlaps the remaining half of the band of the third liquid crystal region 38 of the second liquid crystal layer. A light absorption layer 48 is formed under the transparent substrate 33 under the first liquid crystal layer.

In FIGS. 5A to 5C, the transparent substrate 32 under the first liquid crystal layer and the transparent substrate above the second liquid crystal layer are shared. Alternatively, the first liquid crystal layer and the second liquid crystal layer may be independently formed and then attached together on the lower substrate of the first liquid layer and the upper substrate of the second electrode layer.

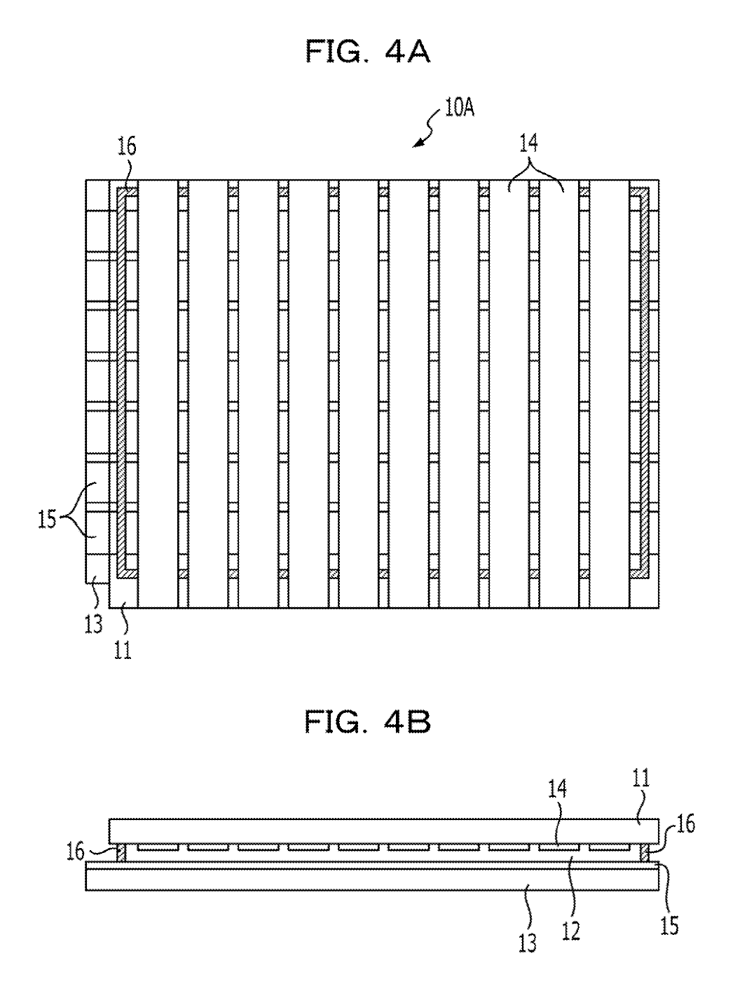

The reflective type color liquid crystal display device of the first embodiment illustrated in FIGS. 5A to 5C is producible like the display device of one layered structure of FIGS. 4A and 4B, except forming two regions by partitions 34 and 35.

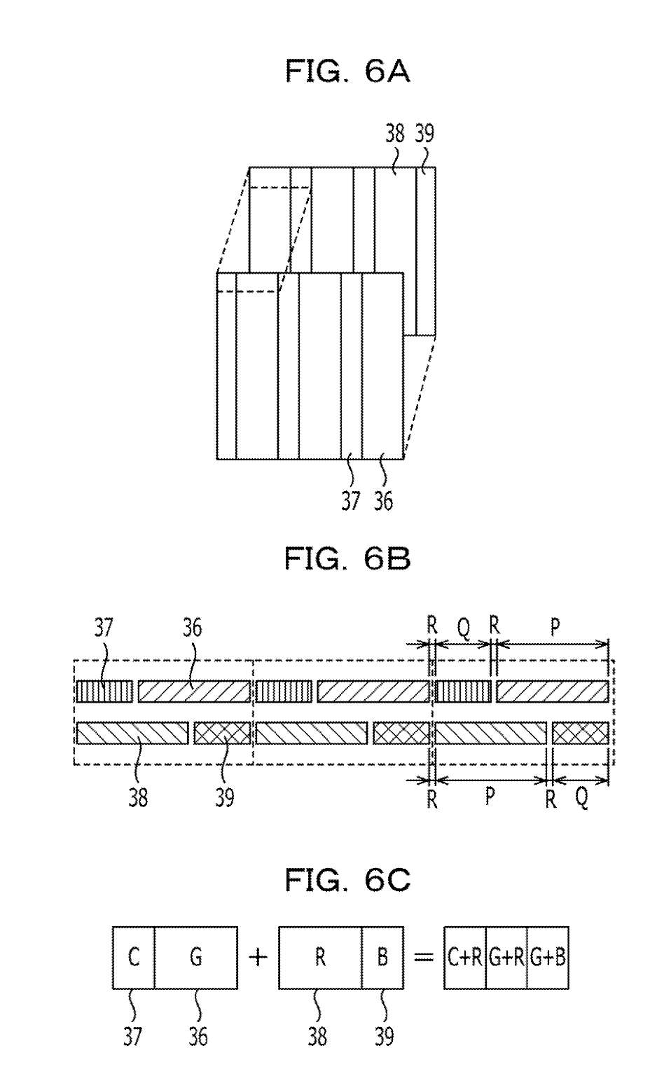

FIGS. 6A to 6C are diagrams that represent two liquid crystal regions are overlapped. FIG. 6A illustrates a positional relation of overlapping, FIG. 6B illustrates an extension of overlapping of the liquid crystal regions, and FIG. 6C illustrates a pixel configuration and display color.

Although the direction with which the band of each domain is tinged is the same as illustrated in FIG. 6A, the position of the band of second liquid crystal region 37 where width is narrow, and the position of the band of fourth liquid crystal region 39 have shifted. Therefore, three kinds of overlapped portions can be made. That is, the overlapped portion between the first liquid crystal region 36 and third liquid crystal region 38, the overlapped portion between the first liquid crystal region 36 and fourth liquid crystal region 39, and the overlapped portion of second liquid crystal region 37 and third liquid crystal region 38. Three sub-pixels included in three adjoining regions form one pixel. That is, one pixel is formed by three sub-pixels located on an intersecting portion where three sub-pixels at the adjoining three second electrodes 45 and three fourth electrodes 47, which are overlapped with each other, and one first electrode 44 and one third electrode 46, which are overlapped with each other. In other words, one pixel may be formed using six sub-pixels in total of three sub-pixels of the first layer and three sub-pixels of the second layer.

More specifically, it will be described with reference to FIG. 6B. In FIG. 6B, a region surrounded by a dashed line corresponds to one pixel. In the figure, P, Q, and R correspond to the band widths and the spaces from the first liquid crystal region 36 to the fourth liquid crystal region 39. The band widths of the first liquid crystal region 36 and the third liquid crystal region 38 is represented by P and the band widths of the second liquid crystal region 37 and the fourth liquid crystal region 39 are represented by Q. The space between the first liquid crystal region 36 and the second liquid crystal region 37, the space between the third liquid crystal region 38 and the fourth liquid crystal region 39, and the space between the adjacent pixels are represented by R. Here, P=160 μm, Q=80 μm, and R=10 μm.

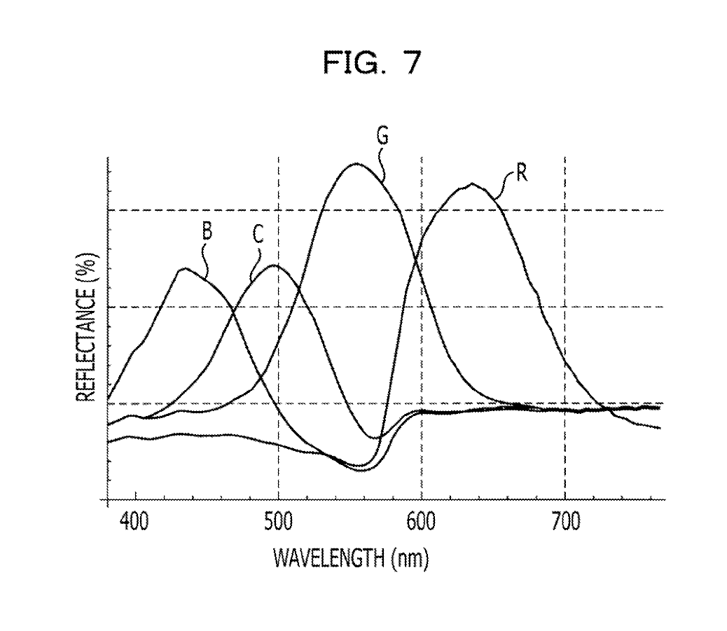

FIG. 7 illustrates reflection spectra when the regions from the first liquid crystal region 36 to the fourth liquid crystal region 39 are brought into a planar state in the first embodiment. In FIG. 7, B represents a reflection spectrum of the fourth liquid crystal region 39, C represents a reflection spectrum of the second liquid crystal region 37, G represents a reflection spectrum of the first liquid region 36, and R represents a reflection spectrum of the third liquid crystal region 38. When a ratio of liquid crystals in the focal conic state is increased in each pixel from the first liquid crystal region 36 and the fourth liquid crystal region, the intensity (reflectance) of each reflection spectrum decreases. When all the liquid crystals become a focal conic state, the reflectance becomes substantially zero.

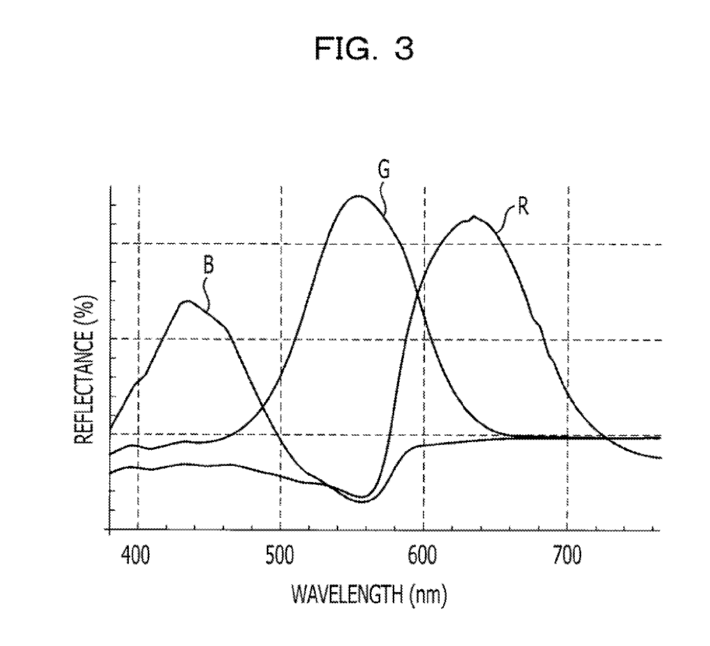

The reflection center wavelength of reflection-spectrum B is about 430 nm, the reflection center wavelength of reflection-spectrum G is about 550 nm, the reflection center wavelength of reflection-spectrum R is about 630 nm, and the reflection center wavelength of reflection-spectrum C is about 500 nm. Reflection-spectrum B, G, and R are the same as the example illustrated in FIG. 3. Reflection-spectrum C is what is called a cyan (Cyan) color.

Regions from the first liquid crystal region 36 to the fourth liquid crystal region 39 have the above reflection spectra. Therefore, a color which can be represented by one pixel is illustrated in FIG. 6C. A first sub-pixel, G+B, is obtained by stacking the first liquid crystal region 36 as a first layer and a fourth liquid crystal 39 as a second layer. A second sub-pixel, G+R, is obtained by stacking the first liquid crystal region 36 as a first layer and a third liquid crystal 38 as a second layer. A third sub-pixel, C+R, is obtained by stacking the second liquid crystal region 37 as a first layer and a third liquid crystal 38 as a second layer. When carrying out on-off control of each sub-pixel, the first sub-pixel can display black B, green G, blue B, and color mixing G+B of green and blue. The same is also applied to the second and third sub-pixels. Therefore, in one pixel, 4×4×4=64 colors can be displayed. If each sub-pixel is controlled so as to be displayed as halftone, the number of display colors may be further increased.

Here, the case where the regions from the first liquid crystal region 36 to the fourth liquid crystal region 39 are filled up with the liquid crystals of three different reflection spectra illustrated in FIG. 3 is compared with the case of a first example.

For the comparison, the regions from the first liquid crystal region 36 to the fourth liquid crystal region 39 assume three kinds of reflection spectra illustrated in FIG. 3. For example, second liquid crystal region 37 assumes blue B, third liquid crystal region 38 assumes red R, and fourth liquid crystal region 39 assumes blue B, the first liquid crystal region 36 assumes green G. In this case, the display of red (R), green (G), blue (B), cyan (C), magenta (M), yellow (Y), white (W), and black (B) can be performed by carrying out on-off control of each sub-picture element.

However, in the display of the related art, since spectral luminous efficacy of blue is low, display tends to become dark.

On the other hand, in the first embodiment, the second liquid crystal region 37 is set to have a reflection spectrum of cyan color represented by “C” in FIG. 7. Since the area ratio of pixels of blue to cyan is ½ of green to red, the peaks of those reflection spectra may be also about ½. However, in this case, an increase in brightness may be attained because cyan, which appears to be similar to green, has a high spectral luminous efficacy. In the case of the two-layer structure, there is a small interfacial reflection between or among a film, an oriented film, a liquid crystal, and the like. Thus, even though the density of block may be higher than that of the three layer structure, the advantageous effects of the two layer structure may be also obtained in the first embodiment.

Here, the third liquid crystal region 38 representing red causes much unnecessary reflection at short wavelengths. It has been known that an increase in color purity by application of a cut filter, which absorbs light at short wavelengths, occurs on the incident side of the third liquid crystal region 38.

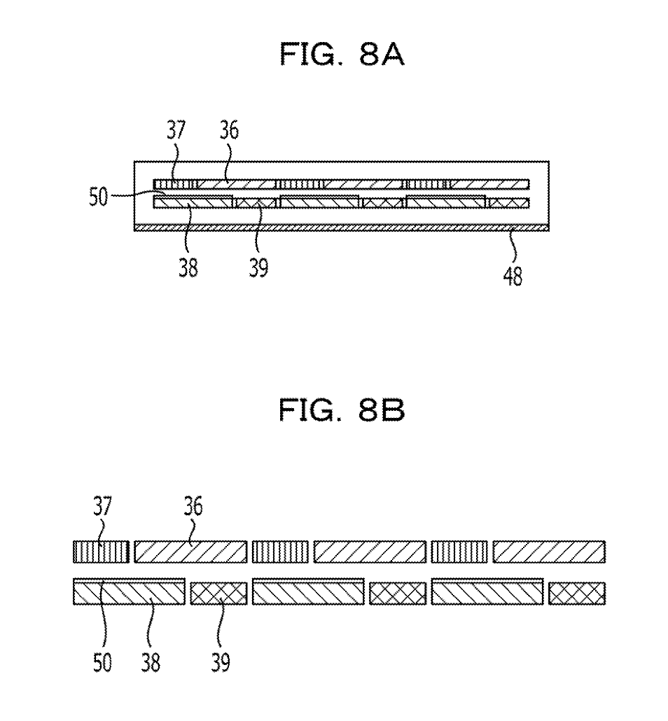

FIG. 8A and FIG. 8B are diagrams each illustrating a cross-sectional view of a modified example of the reflective type color display device of the first embodiment, where FIG. 8A illustrates the whole structure and FIG. 8B illustrates an enlarged pixel part in the first embodiment. In this example, a cut filter 50 is provided so as to correspond to the third liquid crystal region 38 representing red. In FIG. 8A and FIG. 8B, the number of the liquid crystal regions is small to simplify the description. A cut wavelength that reduces a transmittance of the cut filter 50 is at least in a range of a green region (approximately 500 to 600 nm). It is preferable in terms of an improvement in color purity.

A “color volume” in CIELAB color space is considered as the most appropriate index of the color reproduction range. The color reproduction range is a polygon in color space, and the size of the color reproduction range can be expressed with color volume (volume of a polygon). The size of the color reproduction range of the modified example of the first embodiment is compared with the color reproduction range of a comparative example when a the regions from the first liquid crystal region 36 to the fourth liquid crystal region 39 is filled up with the liquid crystals that represent three different reflection spectra illustrated in FIG. 3 using color volume.

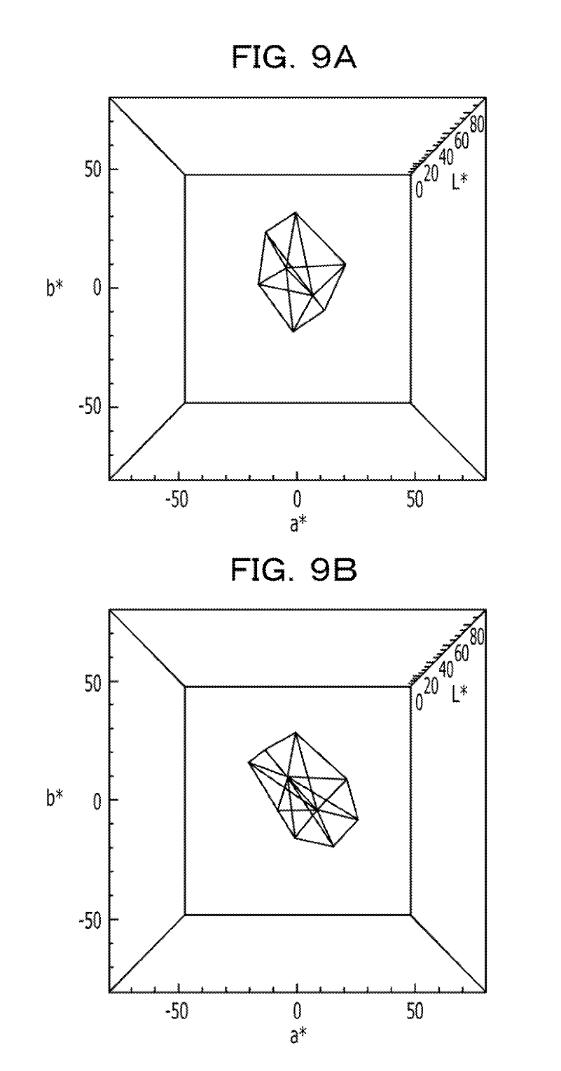

FIG. 9A and FIG. 9B are diagrams illustrating color volumes of a comparative example and a modified example of the first embodiment, respectively. That is, FIG. 9A illustrates the color volume of the comparative example, and FIG. 9B illustrates the color volume of the modified example of the first embodiment. L*, a* and b* are coordinates of the CIE 1976 (L*, a*, b*) color space (also called CIELAB). The CIE 1976 (L*, a*, b*) color space is specified by CIE (Commission Internationale de l'Eclairage). L* means Lightness, a* and b* mean the color-opponent dimensions.

Compared with the case where second liquid crystal region 37 expresses blue, color volume improved 20% or more in the modified example of the first embodiment by changing so that second liquid crystal region 37 may express cyan. In the modified example of the first embodiment, a polygon spreads in the direction of navy blue color to magenta, and may display the color of this direction now more vividly.

In the comparative example, four regions of a fourth liquid crystal region were filled up with the liquid crystal which expresses three colors from the first to fourth liquid crystal regions. In other words, two regions were filled up with the liquid crystal which expresses the same color among four regions. On the other hand, the liquid crystal which expresses four different colors is filled up with first embodiment into four regions from the first to fourth liquid crystal regions. By setting up four different colors suitably, a desired color display is realizable.

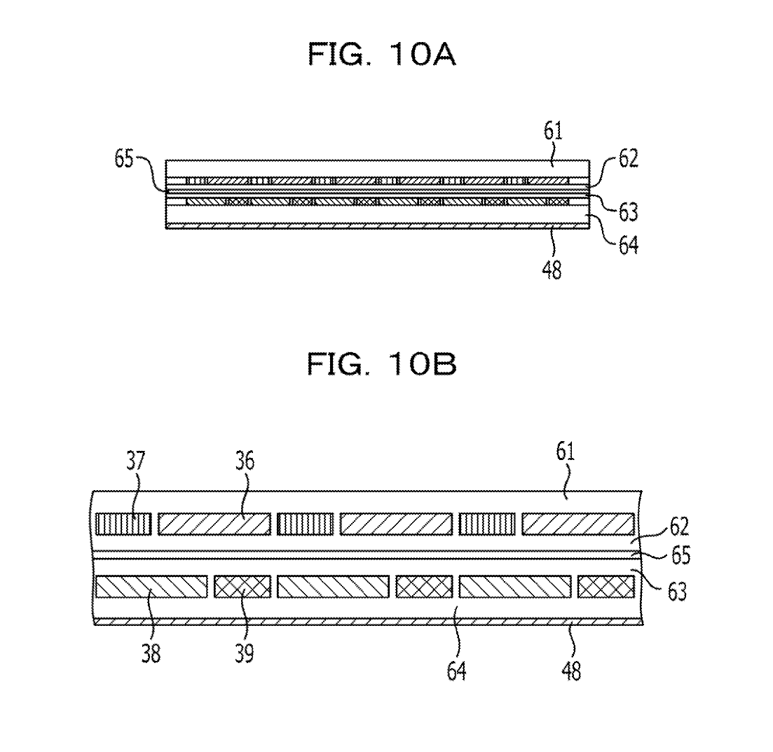

FIG. 10A and FIG. 10B are cross-sectional diagrams of a reflective type color display device according to a second embodiment. FIG. 10A illustrates the whole structure, and FIG. 10B illustrates an enlarged pixel part. In FIG. 10A and FIG. 10B, the number of liquid crystal regions illustrated is small to simplify the description.

A reflective type color display device of a second embodiment has the same configuration as that of the first embodiment, except that, in the reflective type color display device of the second embodiment, a first liquid crystal layer is formed of a single panel and a second liquid crystal layer is formed of a single panel and these panels are pasted together while pixel positions are adjusted.

As illustrated in FIG. 10A and FIG. 10B, a first layered liquid crystal panel has a first liquid crystal layer between an upper substrate 61 and a lower substrate 62. A second layered liquid crystal panel has a second liquid crystal layer between an upper substrate 63 and a lower substrate 64. The first and second liquid crystal layers are planer-shaped as illustrated in FIG. 5. A green cut filter 65 is formed over the lower side of the first layered liquid crystal panel or the upper side of the second layered liquid crystal panel. A light absorption layer 48 is formed over the under side of the second liquid crystal panel. The first layered liquid crystal panel and the second layered liquid crystal panel, which have been prepared above, are pasted together.

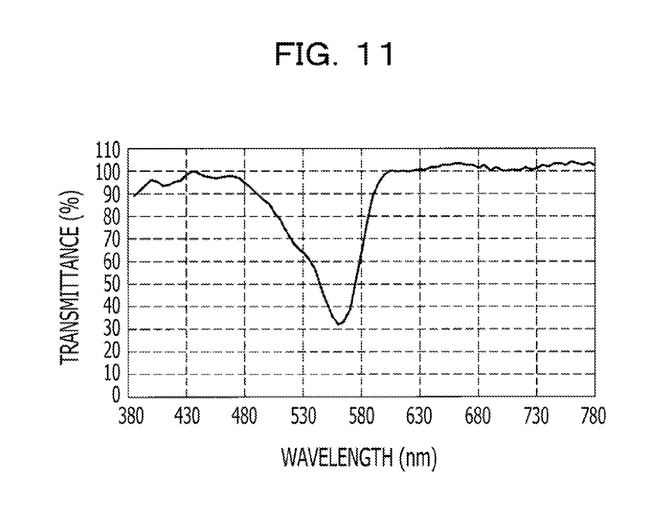

FIG. 11 is a diagram illustrating a transmission spectrum of the green-cut filter 65. As illustrated in FIG. 11, the transmission spectrum of the green cut filter 65 has a high transmittance at wavelengths of 480 nm or less (blue region), and a low transmittance only at a green region. Since the first liquid crystal region 36 which expresses green is mounted on the first layer portion, the green cut filter 65 of such a transmission spectrum leads a high quality display even if the green cut filter 65 is formed over an entire region between the first layer portion and the second layer portion.

Like the modified example of the first embodiment illustrated in FIGS. 8A and 8B, a cut filter 50 is formed so as to correspond to the third liquid crystal region that expresses red. In this case, however, a disadvantage found in the two layer structure (i.e., three colors, RGB, do not simultaneously piled up in vertical direction) appears notably. A striped-shape noise may appear strongly and cause a decrease in visibility. In contrast, the second present embodiment allows the presence of cyan as an intermediate color between blue and green even though three colors of RGB do not simultaneously pile up in the vertical direction. Thus, it suppresses the stripe-shaped noise and reduced and/or prevents visibility from being decreased.

In the first embodiment and its modified example and the second embodiment, first to fourth liquid crystal regions are arranged so that they express green, cyan, red, and blue, but a different combination of four colors may also be used.

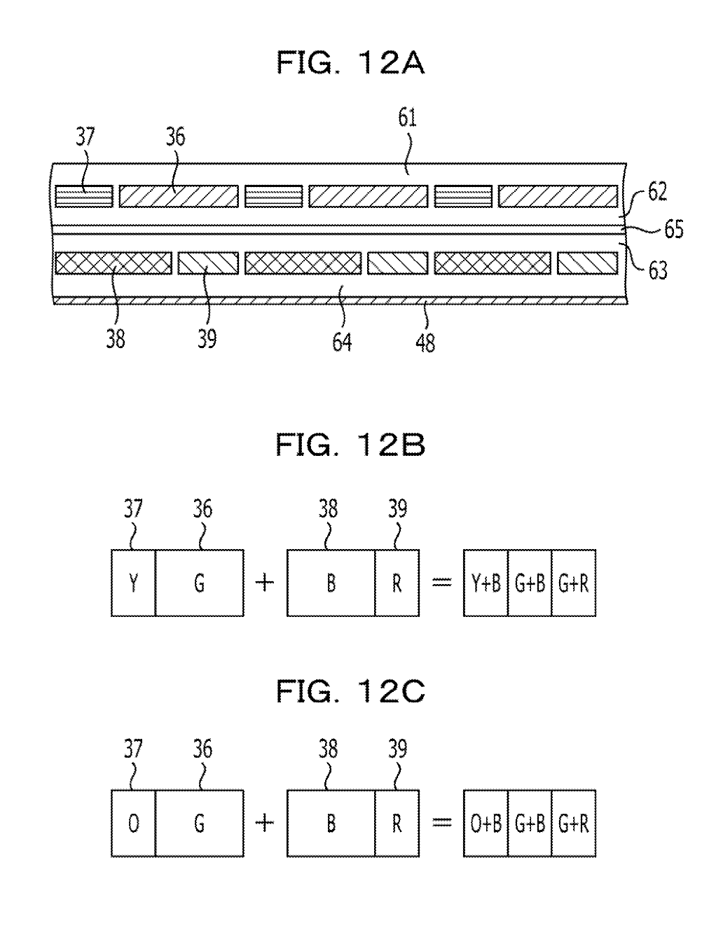

FIGS. 12A to 12C are diagrams illustrating a reflective type color display device of a third embodiment. FIG. 12A illustrates an enlarged cross-sectional view, FIG. 12B illustrates a pixel configuration and a first example of display colors, and FIG. 12C illustrates another pixel configuration and a second example of display colors.

The reflective type color display device of the third embodiment has the same configuration as that of the second embodiment, except that the first to fourth liquid color regions express different colors.

In the reflective type color display device of the third embodiment, a first liquid crystal region 36 expresses green, a third liquid crystal region 38 expresses blue, and a fourth liquid crystal region 39 expresses red. A second liquid crystal region 37 expresses yellow (Y) in a first example and expresses orange (apricot) (O) in a second example. Green, blue, and red have reflection spectra which are similar to those represented for G, B, and R in FIG. 3 and FIG. 7. For example, yellow has a reflection center wavelength near 575 nm and orange has a reflection center wavelength near 590 nm.

In the case of the first example, colors which may be represented by one pixel is illustrated in FIG. 12B. A first sub-pixel, G+R, is obtained by stacking the first liquid crystal region 36 as a first layer and a fourth liquid crystal 39 as a second layer. A second sub-pixel, G+B, is obtained by stacking the first liquid crystal region 36 as a first layer and a third liquid crystal 38 as a second layer. A third sub-pixel, Y+B, is obtained by stacking the second liquid crystal region 37 as a first layer and a third liquid crystal 38 as a second layer.

In the case of Example 2, a color which can be represented by one pixel is illustrated in FIG. 12C. A first sub-pixel, G+R, is obtained by stacking the first liquid crystal region 36 as a first layer and a fourth liquid crystal 39 as a second layer. A second sub-pixel, G+B, is obtained by stacking the first liquid crystal region 36 as a first layer and a third liquid crystal 38 as a second layer. A third sub-pixel, O+B, is obtained by stacking the second liquid crystal region 37 as a first layer and a third liquid crystal 38 as a second layer.

The third embodiment also has improved brightness, contrast, and color reproduction range. However, white may be a little yellowish. First embodiment and its modified example and second embodiment of display quality are more desirable. Here, the materials of the respective parts of a reflective color display device will be described.

Although each of upper substrates and lower substrates has translucency, non-translucency may be sufficient as the lower substrate of a second liquid crystal layer. Examples of the substrate having translucency include a glass substrate, PET, or a PC film substrate.

The upper electrode and the lower electrode are, for example, typically transparent conducting films of ITO (indium tin oxide). Alternatively, transparent conducting films, such as IZO (indium zinc oxide), may be used.

An insulating thin film is formed on an electrode. If this dielectric film is thick, an increase in driver voltage occurs. It becomes impossible to use a general-purpose STN driver. On the contrary, when there is no dielectric film, power consumption increases as the leakage current flows. The dielectric film has a relative dielectric constant of about 5, which is quite lower than that of the liquid crystal. Thus, a preferable thickness of the dielectric film is 0.3 μm or less.

A spacer is placed between the upper substrate 11 and the lower substrate 13. Here, the spacer keeps a gap between substrates substantially uniform. Generally, before pasting upper and lower substrates together, a spherical spacer made of resin or inorganic oxide is sprinkled uniformly on at least one of the substrates. Alternatively, an adherence spacer with which thermoplastic resin is coated on the surface of a substrate is formed. An allowable cell gap formed by the spacer is in the range of 3 to 6 μm. If the allowable cell gap is smaller than the range, a reflectance falls and display becomes dark. Also, high threshold value steepness may be unexpected. On the other hand, if the cell gap is larger than the range, high threshold value steepness may be held, but a driver voltage goes up and the drive by multi-use parts becomes difficult.

Examples of the liquid crystal composition to be introduced into the liquid crystal layer include a cholesteric liquid crystal composition prepared by adding 10 to 40 wt % of a chiral material to a nematic liquid crystal mixture. Here, the amount of the chiral material added is a value when making the total amount of a pneumatic liquid crystal ingredient and a chiral material into 100 wt %. The pneumatic liquid crystal may be any of known materials. An appropriate range of permittivity anisotropy (Δε) is in the range of 15 to 25. If the permittivity anisotropy is 15 or less, on the whole, the driver voltage will become high, and application of multi-use parts will become difficult in the drive circuit. On the other hand, if the permittivity anisotropy becomes 25 or more, the region of the applied voltage which changes from a planar state to a focal conic state will become small, and will be considered to fall as threshold value steepness. Concern comes out also in the reliability of the liquid crystal material itself.

A preferable refractive index anisotropy (Δn) is in the range of about 0.18 to 0.25. If it is smaller than this range, the reflectance of a planar state will become low. If it is larger than this range, the scatter reflections in a focal conic state will become large, and also viscosity becomes high and responsivity falls.

The center wavelength of the catoptric light which a liquid crystal region expresses falls almost linearly as the addition of a chiral material increases. Then, the liquid crystal material to be introduced into the first to fourth liquid crystal regions may be suitably defined by adjusting the addition of a chiral material. Thus, it is possible to adjust the liquid crystal material to express colors, such as blue, green, red, cyan, yellow, and orange.

As described above, in the first to third embodiments and the modified examples thereof, brightness, contrast, and color reproduction range are improved and display quality may be brought close to the display quality of the three-layered reflective color display device. It is noted that there is no rise in manufacturing cost.

Next, a reflective type color liquid crystal display apparatus using the reflective type color liquid crystal display device of any of the first embodiment and its modified example, second embodiment, and third embodiment will be described.

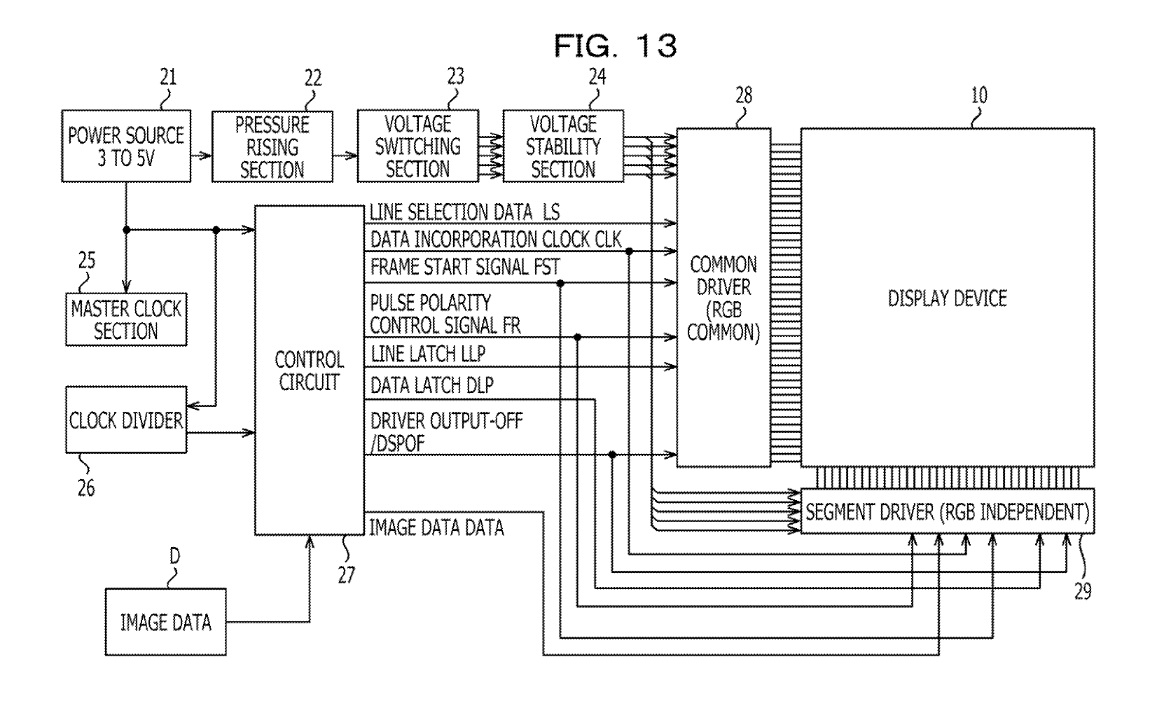

FIG. 13 is a block diagram illustrating a schematic configuration of the reflective type color liquid crystal display apparatus using the reflective type color liquid crystal display device of any of the first embodiment. Examples of a method for driving a cholesteric liquid crystal display device include a DDS drive system and a conventional drive system, which are known in the art. Although the conventional drive system is adopted here, driving using a DDS drive system is also possible.

This reflective type color liquid crystal display apparatus includes a display device 10, a power source 21, a pressure rising section 22, a voltage switching section 23, a voltage stability section 24, a master clock section 25, a dividing section 26, a control circuit 27, a common driver 28, and a segment driver 29. The display device 10 is the reflective type color liquid crystal display device of any of the first to fourth embodiments.

The power source 21 outputs a voltage of about 3 to 5 V, for example. The pressure rising section 22 carries out pressure rising of an input voltage from a power source 21 to +36 V to +40 V by a regulator, such as a DC-DC converter, for example. The voltage switching section 23 generates various levels of voltage with the partial pressure by resistor or the like. The voltage stability section 24 uses a voltage follower circuit of an operational amplifier in order to stabilize various levels of voltage supplied from the voltage switching section 23.

The master clock section 25 generates a basic clock used as basis of operation. The dividing section 26 generates various clocks required for operation the carries out dividing of the basic clock and mentions it later.

The display device 10 is a display device which includes laminated cholesteric liquid crystal panels of RGB and in which color display is possible. For example, it is so-called A4-size XGA specification and has 1024×768 pixels. Here, 1024 data electrodes and 768 scan electrodes are provided, a segment driver 29 drives 1024 data electrodes, and a common driver 28 drives 768 scan electrodes. Since the image data given to each pixel of RGB differs, segment driver 29 drives each data electrode independently. The common driver 28 drives the scan electrode of RGB in common.

By setting up an operation mode, the general-purpose STN driver usable as a segment driver and also as a common driver is produced commercially. Here, a general-purpose STN driver realizes common driver 28 and segment driver 29. The segment driver 29 is set as segment mode, and performs the usual operation. Although the common driver 28 is usually set as the common mode, it is set as the mode which operates as a segment driver here. In Example 1, in order to use it as a common driver after setting a general-purpose STN driver as the mode which operates as a segment driver, a part of power supply voltage supplied to segment driver 29 is replaced, and the common driver 28 is supplied as power supply voltage.

The control circuit 27 generates a control signal based on basic clock, various other clocks, and image data D, and supplies it to the common driver 28 and the segment driver 29. The common driver 28 is data which directs the scan line which provides a preparation pulse, a selection pulse, and an evolution pulse, and line selection data LS is a 2-bit signal here. The image data DATA is data which directs whether segment driver 29 provides voltage to each data electrode in a manner that causes a white display, or a black display. A data incorporation clock CLK is a clock for the common driver 28 and the segment driver 29 to transfer line selection data and image data inside. The frame start signal FSTis a signal which directs the start of the data transfer of the display screen to rewrite. Thus, the common driver 28 and the segment driver 29 reset according to the frame start signal FST. The pulse polarity control signals FR are inversion signals of an applied voltage, and are reversed at the middle time of writing of one line. The common driver 28 and segment driver 29 reverse the polarity of the signal outputted according to pulse polarity control signal FR. The line latch signal LLP is a signal which directs the termination of a line selection data transfer in common driver 28, and latches the line selection data transferred according to this signal. The data latch signal DLP is a signal which directs the termination of transmission of the image data in segment driver 29, and latches the image data transferred according to this signal. A driver output OFF signal/DSPOF is the compulsive OFF signals of an applied voltage.

Operations of the common driver 28 and the segment driver 29 and signals supplied thereto are the same as those generally used in the art.

Here, one pixel is formed by a plurality of sub-pixels of two panels. It is necessary to perform color display control and half tone control in consideration of colors capable of displaying the respective sub-pixels. However, such an image display control method may use the conventional technique and may be easily performed by a person skilled in the art, and thus the description is omitted herein.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A liquid crystal display device, comprising:
a first liquid crystal layer where first liquid crystal regions and second liquid crystal regions are alternately arranged; and
a second liquid crystal layer stacked on the first liquid crystal layer, where third liquid crystal regions and fourth liquid crystal regions are alternately arranged, wherein
with respect to an area per pixel, the first liquid crystal region is larger than the second liquid crystal region, and the third liquid crystal region is larger than the fourth liquid crystal region; and
the first liquid crystal region overlaps part of the third liquid crystal region and the fourth liquid crystal region,
the first liquid crystal region causes a change in reflectance of light at a first wavelength region in response to applied voltage,
the second liquid crystal region causes a change in reflectance of light at a second wavelength region in response to applied voltage,
the third liquid crystal region causes a change in reflectance of light at a third wavelength region in response to applied voltage,
the fourth liquid crystal region causes a change in reflectance of light at a fourth wavelength region in response to applied voltage, and
the first wavelength region, the second wavelength region, the third wavelength region, and the fourth wavelength region are different from one another.

2. The liquid crystal display device according to claim 1, wherein
the surface ratio of the first liquid crystal region and the second liquid crystal region is 2:1, and
the surface ratio of the third liquid crystal region and the fourth liquid crystal region is 2:1.

3. The liquid crystal display device according to claim 1, wherein
the wavelength region with the highest spectral luminous efficacy is the first wavelength region or the third wavelength region among the first wavelength region to the fourth wavelength region.

4. The liquid crystal display device according to claim 1, wherein
the wavelength region with the lowest spectral luminous efficacy is the second wavelength region or the fourth wavelength region among the first wavelength region to the fourth wavelength region.

5. The liquid crystal display device according to claim 1, wherein
among the region from the first wavelength region to the fourth wavelength region, a wavelength region for neutral colors between the wavelength regions with the highest spectral luminous efficacy is the second wavelength region or the fourth wavelength region.

6. The liquid crystal display device according to claim 5, wherein
one of a color exerted by the first wavelength region and a color exerted by the third wavelength region is green and the other is red, and
one of a color exerted by the second wavelength region and a color exerted by the fourth wavelength region is blue and the other is neutral color.

7. The liquid crystal display device according to claim 5, wherein
the first wavelength region, second wavelength region, third wavelength region, and fourth wavelength region exert blue, green, red, and neutral color between green and red;
one of a color exerted by the first wavelength region and a color exerted by the third wavelength region is green and the other is blue;
one of a color exerted by the second wavelength region and a color exerted by the fourth wavelength region is red and the other is the neutral color.

8. The liquid crystal display device according to claim 1, wherein
an upper layer of the first liquid crystal layer and the second liquid crystal layer includes a liquid crystal region that expresses green, and
a lower layer of the first liquid crystal layer and the second liquid crystal layer includes a liquid crystal region that expresses red, and
a green cut filter is provided corresponding to the liquid crystal region that expresses the red to reduce incident of green light on the liquid crystal region that expresses the red.

9. The liquid crystal display device according to claim 1, wherein
an upper layer of the first liquid crystal layer and the second liquid crystal layer includes a liquid crystal region that expresses green, and
a lower layer of the first liquid crystal layer and the second liquid crystal layer includes a liquid crystal region that expresses red, and
a green cut filter is interposed between the upper layer and the lower layer.

10. The liquid crystal display device according to claim 9 and wherein
the green cut filter absorbs a green wavelength region and permeates a red wavelength region.

11. The liquid crystal display device according to claim 1, wherein
at least one of the first liquid crystal region, second liquid crystal region, third liquid crystal region, and fourth liquid crystal region includes a cholesteric liquid crystal.

12. A liquid crystal display apparatus, comprising:
a liquid crystal display device including a first liquid crystal layer and a second liquid crystal layer which are stacked, and
a voltage applying circuit that applies a voltage to a region selected from the first liquid crystal layer and the second liquid crystal layer, wherein
the first liquid crystal layer includes first liquid crystal regions and second liquid crystal regions which are alternately arranged in parallel;
the second liquid crystal layer includes third liquid crystal regions and fourth liquid crystal regions which are alternately arranged in parallel;
the first liquid crystal region causes a change in reflectance of light at a first wavelength region in response to applied voltage,
the second liquid crystal region causes a change in reflectance of light at a second wavelength region in response to applied voltage,
the third liquid crystal region causes a change in reflectance of light at a third wavelength region in response to applied voltage,
the fourth liquid crystal region causes a change in reflectance of light at a fourth wavelength region in response to applied voltage, and
the first wavelength region, second wavelength region, third wavelength region, and fourth wavelength region are different from one another.
